(19) United States
(12) Patent Application Publication
(10) Pub. No.: US 2025/0199566 A1
(43) Pub. Date: Jun. 19, 2025

(54) REDUCED LATENCY CLOCK DOMAIN CROSSING CIRCUIT

(71) Applicant: Rambus Inc., San Jose, CA (US)

(72) Inventor: Yu-Cheng Liao, Zhubei City (TW)

(21) Appl. No.: 18/966,665

(22) Filed: Dec. 3, 2024

Related U.S. Application Data
(60) Provisional application No. 63/612,174, filed on Dec. 19, 2023.

(51) Int. Cl. G06F 1/12

(52) U.S. Cl. CPC G06F 1/12

(57) ABSTRACT

A clock domain crossing (CDC) circuit receives a first data. The CDC circuit includes a first buffer and a second buffer. The first buffer includes a single-clock static random-access memory. The second buffer includes a plurality of data flip-flops. Logic coupled to the first buffer and the second buffer can determine that first buffer is not full at a first time. Responsive to the determination that the second buffer is not full at the first time, the processing logic can bypass the first buffer to write the first data to the second buffer according to the first clock domain. The processing logic can provide the first data as output from the second buffer according to the second clock domain.

### RELATED APPLICATIONS

This application claims the benefit of U.S. Provisional Application No. 63/612,174, filed Dec. 19, 2023, the entire contents of which is incorporated herein by reference.

### TECHNICAL FIELD

The present disclosure relates to the field of clock domain crossing (CDC), in particular, to a reduced latency CDC circuit.

### BACKGROUND

In complex digital systems, different components may operate according to different clock domains due to varying functionalities, performance requirements, or interfaces. When data crosses between clock domains, potential issues may arise associated with timing, metastability, and synchronization. CDC circuits may ensure that data crossing between time domains adheres to timing requirements.

### BRIEF DESCRIPTION OF THE DRAWINGS

FIG. 1 is a diagram of an example system-on-chip including a reduced latency CDC circuit to pass data from a source clock domain to a destination clock domain, in accordance with some embodiments of the present disclosure.

FIG. 2 is a block diagram of an example implementation of a reduced latency CDC circuit, in accordance with some embodiments of the present disclosure.

FIG. 3 is a block diagram of an example implementation of a data flip-flop (DFF) buffer and a CDC latch array, in accordance with some embodiments of the present disclosure.

FIG. 4 is a process flow diagram of a method of crossing a clock domain using a reduced latency CDC circuit, in accordance with some embodiments of the present disclosure.

FIG. 5 depicts a diagram of an example computer system in which embodiments of the present disclosure may operate.

### DETAILED DESCRIPTION

In many digital processing systems, it is common to have multiple clock domains. A clock domain can include sequential logic (Flip-Flops, registers, random-access memories (RAMs), etc.) that operate according to the same clock cycles. Having multiple clock domains in a digital processing system can allow different components of the system, such as a Field-Programmable Gate Array (FPGA) or a system-on-chip (SoC), etc., to operate at different frequencies. For example, one clock domain may operate at a high frequency to perform computationally intensive tasks while another clock domain may operate at a lower clock frequency to perform less computationally demanding tasks. A synchronization mechanism, such as a clock domain crossing (CDC) circuit, may be used for passing data between the two clock domains to enable the two clock domains to communicate.

Conventional systems may use a dual-clock asynchronous static random-access memory (SRAM) as a first-in, first-out (FIFO) CDC circuit (referred to generally as “dual-clock SRAM FIFO” or “dual-clock SRAM” herein) to transfer data between two clock domains. The dual-clock SRAM FIFO can be a buffer that a source writes the data into via a write port according to the source clock domain, and the destination reads data out of the dual-clock SRAM via a read port according to the destination clock domain. Dual-clock SRAM circuits may add latency due to synchronization and handshake mechanisms associated with dual-clock SRAM. Additionally, meeting timing constraints, such as setup and hold timing constraints can become challenging in dual-clock SRAM circuits, especially at high frequencies (e.g., 1 gigahertz (GHz) or more). Furthermore, the depth of the dual-clock SRAM FIFO may be large to prevent overflow or underflow of data. While increasing the size of the SRAM FIFO may help overflow and underflow of data at high frequencies, it may also introduce additional latency. For example, transferring data (and associated read/write pointers) between a source clock domain and destination clock domain using a dual-clock SRAM FIFO can incur five to six clock cycles of latency.

Aspects and implementations of the present disclosure address the above and other deficiencies by providing a reduced latency CDC circuit for clock domain crossing. Specifically, the CDC circuit includes a single-clock SRAM FIFO buffer (referred to generally as “single-clock SRAM buffer” herein) and a data flip-flop (DFF) FIFO buffer (referred to generally as “DFF buffer” herein). The single-clock SRAM buffer may include a read port and write port clocked according to a source clock domain. The DFF buffer may include a write port clocked according to the source clock domain and a read port clocked according to a destination clock domain. In operation, the CDC circuit may receive data from a source according to the source clock domain and provide data to a destination according to the destination clock domain. If the DFF buffer is not full, the CDC circuit can (e.g., using control logic) bypass the single-clock SRAM buffer and route the data directly to the DFF buffer. If the DFF buffer is full, the control logic of the CDC circuit can route the data to the single-clock SRAM buffer. In response to determining that data is available in the single-clock SRAM buffer, the control logic can read data from the single-clock SRAM buffer and write the data to DFF buffer to fill the DFF buffer. The data can be read out from the DFF buffer to the destination according to the destination clock domain.

Technical advantages of the present disclosure include reducing latency of a CDC circuit, allowing the CDC circuit, a source circuit, and/or a destination circuit to operate at an increased overall frequency without timing experiencing timing issues associated with a dual-clock SRAM CDC circuit, thereby improving performance. Additionally, latency associated with transferring data between clock domains can be reduced. For example, the transferring data between a source clock domain and a destination clock domain using the reduced latency CDC circuit describe herein can incur reduced latency (e.g., two to three cycles of latency), as opposed to longer latency (e.g., five to six cycles of latency) associated with conventional dual-clock SRAM CDC circuits. Furthermore, an overall area and associated power consumption of the CDC circuit can be reduced as the reduced area of the single-clock SRAM buffer can compensate for the DFF buffer for an overall area that is less than a conventional dual-clock SRAM CDC circuit.

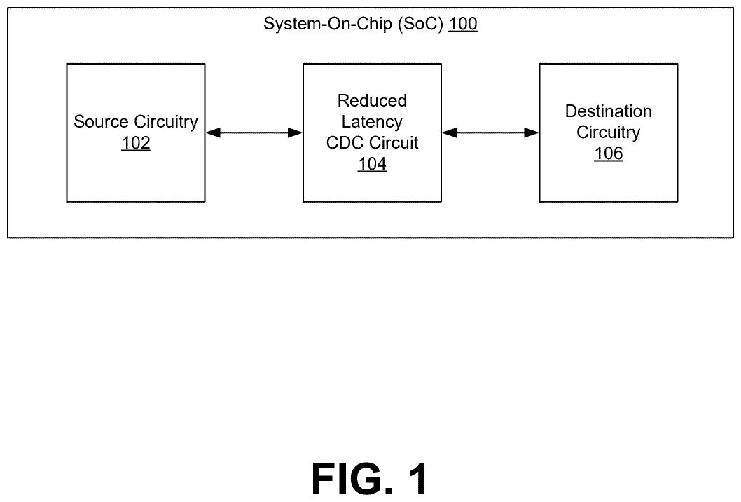

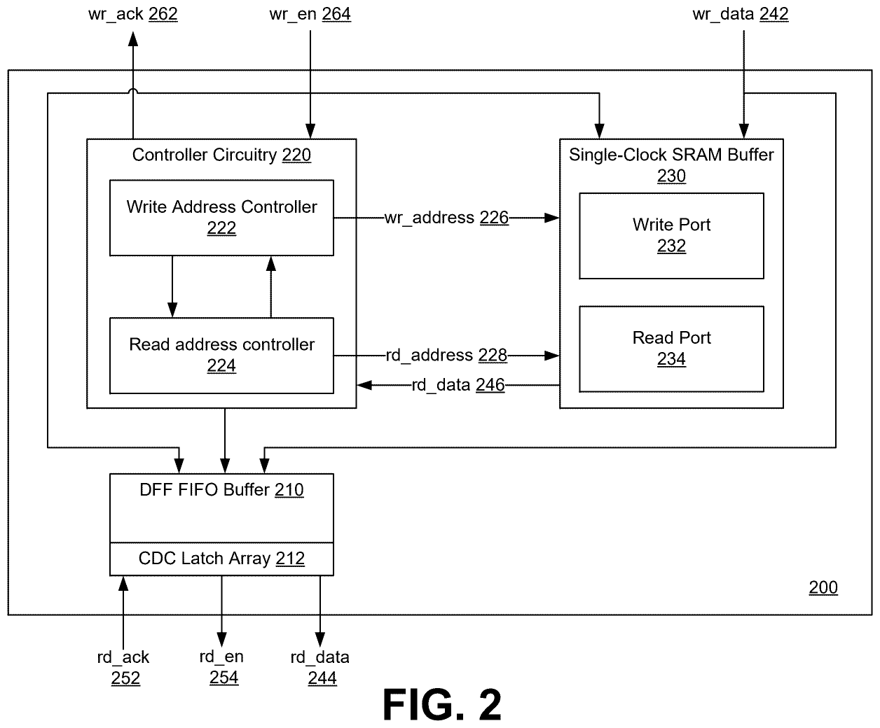

FIG. 1 is a diagram of an example system-on-chip (“SoC”) 100 including a reduced latency CDC circuit 104 to pass data from a source clock domain to a destination clock domain, in accordance with some embodiments of the present disclosure. An SoC can refer to an integrated circuit that integrates multiple components of a system. In some embodiments, the SoC 100 can include a source circuitry 102, a reduced latency CDC circuit 104, and a destination circuitry 106. The source circuitry 102 is on a write side of the reduced latency CDC circuit 104, operating according to a source clock domain of the source circuitry 102. The destination circuitry 106 is on a read side of the reduced latency CDC circuit 104, operating according to a destination clock domain of the destination circuitry 106. In some embodiments, the reduced latency CDC circuit 104 can be a FIFO memory buffer to pass data from the source clock domain of the source circuitry 102 to the destination clock domain of the destination circuitry 106. In some embodiments, the reduced latency CDC circuit can include a single-clock SRAM FIFO buffer and a DFF FIFO buffer, as described below with respect to FIG. 2.

It is appreciated that SoC 100 is provided herein by way of example, and not by way of limitation, noting that the reduced latency CDC circuit 104 can be implemented within other systems such as Field-Programmable Gates Arrays (FPGAs), Application-Specific Integrated Circuits (ASICs), embedded systems, Digital Signal Processors (DSPs), communication systems, memory subsystems, and/or the like. Generally, the source circuitry 102 can be a region of a digital system including, for example, processing cores, DSPs, memory components, peripheral interfaces, Input/Output (I/O) modules, controllers, and/or the like, associated with the source clock domain. The destination circuitry 106 can be another region of the digital system including, for example, processing cores, DSPs, memory components, peripheral interfaces, Input/Output (I/O) modules, controllers, and/or the like, associated with the destination clock domain.

FIG. 2 is a block diagram of an example implementation of a reduced latency CDC circuit 200, in accordance with some embodiments of the present disclosure. The reduced latency CDC circuit 200 includes a DFF FIFO buffer 210, controller circuitry 220, and a single-clock SRAM buffer 230. The reduced latency CDC circuit 200 can receive write data 242 (wr_data) from a source, such as source circuitry 102 of FIG. 1, according to a source clock domain. In some embodiments, the source clock can be received over an external interface, such as a Peripheral Component Interconnect Express (PCIe), a bus, or the like. In some embodiments, the source clock domain can be a variable clock domain based on a link speed associated with the external link.

When the reduced latency CDC circuit 200 receives the write data 242, the controller circuitry 220 can determine whether to write the write data 242 to the single-clock SRAM buffer 230 or to the DFF FIFO buffer 210 based on whether the DFF FIFO buffer 210 is full. If the DFF FIFO buffer 210 is full, the controller circuitry 220 can write the data to the single-clock SRAM buffer 230. If the DFF FIFO buffer 210 is not full, the controller circuitry 220 can bypass the single-clock SRAM buffer 230 and write the data to the DFF FIFO buffer 210. If the DFF FIFO buffer 210 is full and/or the single-clock SRAM buffer 230 is not empty, the controller circuitry 220 can write the data to the single-clock SRAM buffer 230.

In some embodiments, the single-clock SRAM buffer 230 can be a FIFO memory that buffers write data 242. The single-clock SRAM buffer 230 includes a write port 232 and a read port 234. The write port 232 is an interface through which data, such as write data 242, is written into the single-clock SRAM buffer 230. The data can be written through the write port 232 according to a write address 226 (wr_address), as managed by the controller circuitry 220. When the single-clock SRAM buffer 230 is not empty and/or when the DFF FIFO buffer 210 is not full, the controller circuitry 220 can cause data stored within the single-clock SRAM buffer 230 to be read from the single-clock SRAM buffer 230 and written into the DFF FIFO buffer 210. Data can be read from the single-clock SRAM buffer 230 through the read port 234 according to a read address 228 (rd_address), as managed by the controller circuitry 220. The read port 234 is an interface through which data can be read from the single-clock SRAM buffer 230. In some embodiments, the single-clock SRAM buffer 230 can be a synchronous memory including synchronous interfaces. For example, the write port 232 and the read port 234 can be synchronous interfaces. Accordingly, the controller circuitry 220 can initiate a write operation on a source clock edge, and the data can be latched into the single-clock SRAM buffer 230 on the following source clock edge. Similarly, the data can be read from the single-clock SRAM buffer 230 in synchronization with the source clock. The controller circuitry 220 can initiate a read operation on a source clock edge, and the read data is available on the next source clock edge.

The controller circuitry 220 can include a write address controller 222 and a read address controller 224. The write address controller 222 can control a write pointer to determine the write address 226 that data should be written to in the single-clock SRAM buffer 230. When a write operation occurs (enqueuing data into the single-clock SRAM buffer 230), the write address controller 222 can advance the write pointer to the next position in the single-clock SRAM buffer 230. The read address controller 224 can control a read pointer to determine read address 228 where data should be read from the single-clock SRAM buffer 230. When a read operation occurs (dequeuing data from the single-clock SRAM buffer 230 into the DFF FIFO buffer 210), the read address controller 224 can advance the read pointer to the next position in the single-clock SRAM buffer 230. Read data 246 (rd_data) can be read from the single-clock SRAM buffer 230 and written into the DFF FIFO buffer 210 when it is determined that the single-clock SRAM buffer 230 is not empty and that the DFF FIFO buffer 210 is not full. To determine whether the single-clock SRAM buffer 230 is empty, the controller circuitry 220 can compare the write pointer and the read pointer. If the read pointer is equal to the write pointer, it indicates that there are no elements between them, and that the single-clock SRAM buffer 230 is empty.

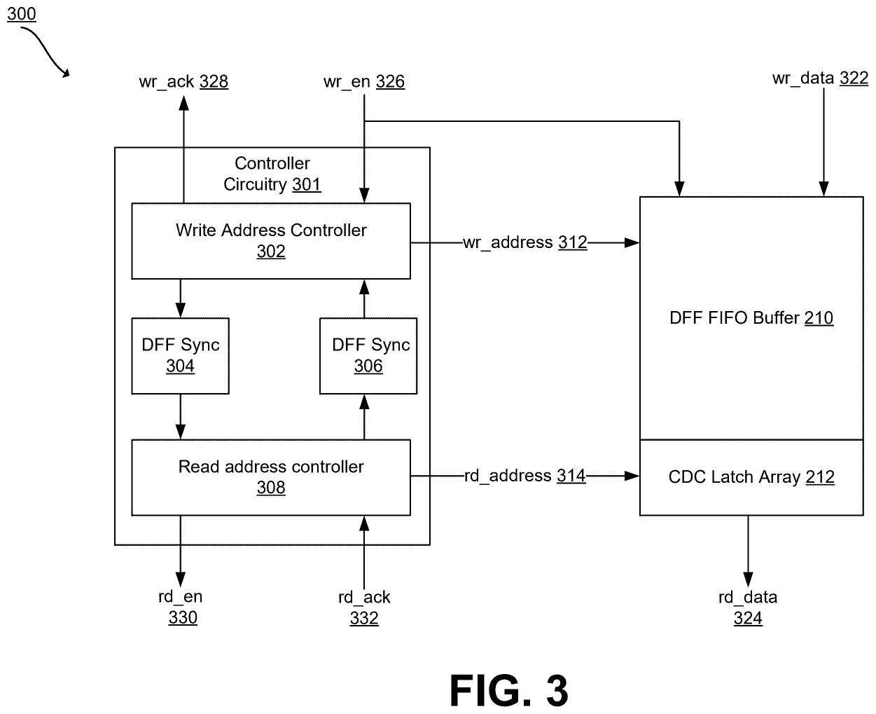

As indicated above, if the DFF FIFO buffer 210 is not full and/or if the single-clock SRAM buffer 230 is empty, the write data 242 can bypass the single-clock SRAM buffer 230 and be written directly into the DFF FIFO buffer 210. Data flip-flops (DFFs) can be used as the basic storage elements within the DFF FIFO buffer 210. In some embodiments, DFF FIFO buffer 210 can be an asynchronous FIFO memory buffer to accommodate data transfer from the source clock domain to the destination clock domain. When data is to be written to into the DFF FIFO buffer 210, the write operation is synchronized with the source clock domain. When data is read from the DFF FIFO buffer 210, the read operation is synchronized with the destination clock domain. The DFF FIFO buffer 210 can be dual-ported, allowing for simultaneous read operations and write operations. For example, data can be written to the DFF FIFO buffer 210 according to the source clock domain, and data can be read out of the CDC Latch Array 212 according to the destination clock domain, as illustrated bellow with respect to FIG. 3.

In some embodiments, the DFF FIFO buffer 210 and the single-clock SRAM buffer 230 can facilitate transfer of data from the source clock domain to the destination clock domain using a handshaking mechanism. The handshaking mechanism can include the read acknowledge 252 (rd_ack) signal. The read acknowledge 252 signal is generated by the destination clock domain to acknowledge the successful reception and processing of read data 244 (rd_data). The read acknowledge 252 signal can indicate that data transfer to the destination has been completed and it is safe to proceed with additional read operations or new write operations. The handshake mechanism can include write acknowledge 262 (wr_ack) signal. In some embodiments, controller circuitry 220 and/or controller circuitry associated with the DFF FIFO buffer 210 can assert the write acknowledge 262 signal when the single-clock SRAM buffer 230 or the DFF FIFO buffer 210 is not full. The write acknowledge 262 can indicate to the source that write data 242 can be latched into the single-clock SRAM buffer 230 or to the DFF FIFO buffer 210. When the source initiates a write operations, the source may wait for a corresponding write acknowledge 262 signal before proceeding with subsequent write operations. If both the single-clock SRAM buffer 230 and the DFF FIFO buffer 210 are full, the controller circuitry 220 and/or the DFF FIFO buffer 210 controller circuitry can de-assert the write acknowledge 262 signal. Accordingly, the read acknowledge 252 and write acknowledge 262 signals can establish a reliable communication link between clock domains, ensuring proper data transfer, and providing feedback regarding status of data processing.

In some embodiments, the handshaking mechanism can include a read enable 254 (rd_en) signal and a write enable 264 (wr_en) signal. The DFF FIFO buffer 210 can assert the read enable 254 signal when read data 244 is available to be read out of the DFF FIFO buffer 210. In some embodiments, the read enable 254 signal can be synchronized with the destination clock to ensure that the read operation occurs at a point in time within the destination clock domain. The write enable 264 signal determines whether a write operation is allowed or enabled in the source clock domain. The source can assert the write enable 264 signal to indicate that a write operation is permitted, and data presented at the write port 232 or the write port associated with the DFF FIFO buffer 210 can be written into the single-clock SRAM buffer 230 or the DFF FIFO buffer 210, respectively. The coordination between read enable 254, read acknowledge 252, write enable 264, and write acknowledge 262 signals forms the handshaking mechanism that ensures proper synchronization of read and write operations across the source clock domain and the destination clock domain.

It is appreciated that the single-clock SRAM buffer 230 and DFF FIFO buffer 210 are used herein by way of example, and not by way of limitation. Noting, that other memory buffer devices may be used herein in association with the described techniques. For example, the single-clock SRAM buffer 230 can generally be replaced with any synchronous, single-clock memory buffer device, such as a register file.

FIG. 3 is a block diagram 300 of an example implementation of a data flip-flop (DFF) FIFO buffer 210 and a CDC latch array 212, in accordance with some embodiments of the present disclosure. The block diagram 300 includes controller circuitry 301 including a write address controller 302 and a read address controller 308. The write address controller 302 generates and controls a write pointer that indicates a write address 312 (wr_address) where data should be written into the DFF FIFO buffer 210. The read address controller 308 generates and controls a read pointer that indicates a read address 314 (rd_address) which data should be read from the DFF FIFO buffer 210. The write pointer and read pointer can be managed as circular buffer by write address controller 302 and read address controller 308, respectively. In some embodiments, the control circuitry 301 can determine whether the DFF FIFO buffer 210 is full or whether the DFF FIFO buffer 210 is empty by comparing the read and write pointers, as similarly described above with respect to the controller circuitry 220 associated with the single-clock SRAM buffer 230 of FIG. 2.

The controller circuitry 301 includes a DFF synchronizer 304 and a DFF synchronizer 306 to facilitate transfer of read and write pointers between the source clock domain and the destination clock domain. However, to know when to write (DFF FIFO Buffer 210 not full) and when to read (DFF FIFO Buffer 210 not empty), the write address controller 302 and read address controller 308 may have a view of read and write pointers, respectively. Accordingly, DFF synchronizer 304 and DFF synchronizer 306 can facilitate transfer of pointers between clock domains to enable respective controllers to perform address pointer comparisons. The DFF synchronizers 304 and 306 can include two or more flip-flops/latches that stabilize address pointers to mitigate metastability. Metastability arises when a flip-flop or latch samples an input signal at a time that violates its setup or hold time requirements. The setup time is the minimum time that the input signal must be stable before the clock edge, and the hold time is the minimum time that the signal must remain stable after the clock edge. When the output of the flip-flop or latch enters a state that is neither high nor low, this state is referred to as a metastable state. The DFF synchronizer 304 and the DFF synchronizers 306 can prevent such metastability issues using multiple flip-flops/latches (2-FF synchronizer, 3-FF synchronizers, etc.).

In an illustrative example, the DFF synchronizer 304 can be a dual flip-flop synchronizer in which two flip-flops are connected in series in the destination clock domain. If the first flip-flop enters a metastable state (e.g., due to setup violation, hold violations, etc.), the second flip-flop provides enough time for the first flip-flop to stabilize when providing the write address pointer to the read address controller. Similarly, the DFF synchronizer 306 can be a dual flip-flop synchronizer in which two flip-flops are connected in series from the destination clock domain to the source clock domain. If the first flip-flop enters a metastable state (e.g., due to setup violation, hold violations, etc.), the second flip-flop provides enough time for the first flip-flop to stabilize when providing the read address pointer to the write address controller 302.

Write data 322 (wr_data) can be written into the DFF FIFO buffer 210 according to the source clock domain. Data can be read out from the DFF FIFO buffer 210 and latched into the CDC latch array 212 based on the read address 314. Read data 324 (rd_data) can be read out of the CDC latch array 212 according to the destination clock domain to thereby allow transfer of data between the source clock domain and the destination clock domain. In some embodiments, the read data 324 can be read out of the CDC latch array 212 using a handshaking mechanism including multiple enable and acknowledge signals, as similarly described above with respect to FIG. 2.

The handshaking mechanism can include the write acknowledge signal 328 (wr_ack), the write enable signal 326 (wr_en), the read enable signal 330 (rd_en), and the read acknowledge signal 332 (rd_ack). The controller circuitry 301 can assert the write acknowledge signal 328 when DFF FIFO Buffer 210 is full, indicating that write data 322 should be written to the single-clock SRAM buffer, such as single-clock SRAM buffer 230 of FIG. 2. The controller circuitry 301 can assert the read enable signal 330 when the DFF FIFO buffer 210 is not empty, indicating to the destination clock domain that read data 324 may be read out from the CDC latch array 212.

The controller circuitry 301 can receive the write enable signal 326, indicating that the write data 322 may be written into the DFF FIFO buffer 210. The controller circuitry 301 can receive the read acknowledge signal 332 from the destination clock domain, acknowledging the successful reception and processing of read data 324. The read acknowledge signal 332 can indicate that transfer of read data 324 to the destination has been completed, and that it is safe to proceed with additional read operations.

In some embodiments, the DFF FIFO buffer 210 can be of a sufficient depth to compensate for latency associated with reading data from the single-clock SRAM buffer 230 of FIG. 2 and realize bandwidth requirements associated with transfer data from the first clock domain to the second clock domain. In an illustrative example, the DFF FIFO buffer 210 can include eight data entries that each hold a data element (e.g., 16-bit data elements, 32-bit data elements, etc.) such that latency (e.g., 2-3 cycles of latency) associated with reading data from the single-clock SRAM buffer 230 of FIG. 2 is the same or similar to the latency associated with read data from DFF FIFO buffer 210.

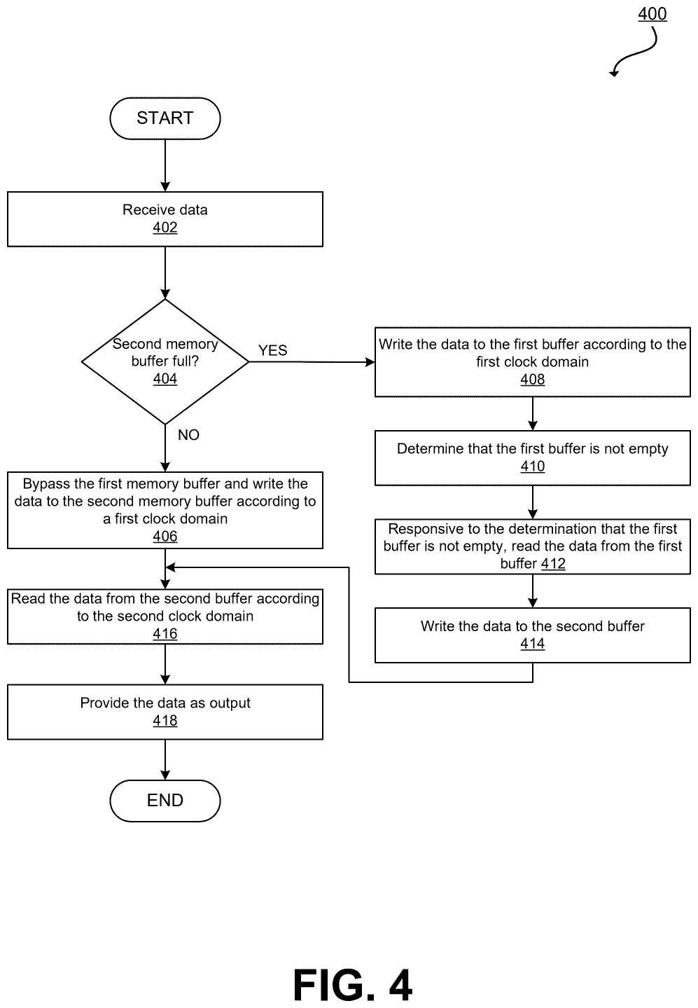

FIG. 4 is a process flow diagram of a method 400 of crossing a clock domain using a reduced latency CDC circuit, in accordance with some embodiments of the present disclosure. Method 400 is performed by processing logic that can include hardware (circuitry, dedicated logic, etc.), software (such as is run on a general-purpose computer system or a dedicated machine), firmware, a finite state machine (FSM), or some combination thereof. In some embodiments, method 400 can be performed by controller circuitry 220, single-clock SRAM buffer 230, DFF FIFO buffer 210, and/or CDC latch array 212 of FIG. 2. In other or similar embodiments, one or more operations of method 400 can be performed by one or more other machines not depicted in the figures.

For simplicity of explanation, the methods are depicted and described as a series of acts. However, acts in accordance with this disclosure may occur in various orders and/or concurrently, and with other acts not presented and described herein. Furthermore, not all illustrated acts may be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 402, processing logic receives a data. In some embodiments, the processing logic can include a clock domain crossing (CDC) circuit. For example, the processing logic can include the reduced latency CDC circuit 200 of FIG. 2. The processing logic can receive the data from a source clock domain, such as source circuitry 102 of FIG. 1. In some embodiments, the CDC circuit can include a first buffer a second buffer. The first and second buffers can be respective memory buffers within the CDC circuit. For example, the first buffer can be the single-clock SRAM buffer 230 of FIG. 2, and the second buffer can be the DFF FIFO buffer 210 of FIG. 2. In some embodiments, the first buffer and second buffer are first-in, first-out memory buffers. In some embodiments, first buffer can be a synchronous buffer and the second buffer can be an asynchronous buffer. Additionally, the first buffer and the second buffer can be implemented using other memory buffer devices. For example, the first buffer can generally be replaced with any synchronous, single-clock memory buffer device, such as a register file.

In some embodiments, the processing logic can receive the first clock domain over an external link. In some embodiments, the first clock domain is variable clock domain based on a link speed associated with the external link.

At block 404, the processing logic can determine whether the second buffer is full or whether the first buffer is not empty. Responsive to a determination that the second memory buffer is not full or that the first memory buffer is empty, the method 400 continues to block 406. Responsive to a determination that the second memory buffer is full, the method 400 continues to block 408. For example, at a first time, the processing logic may receive a first data and determine that the second memory buffer is not full. Accordingly, at the first time, the method 400 can continue to block 406. At a second time, the processing logic can receive a second data and determine that the second memory buffer is full. Accordingly, at the second time, the method can continue to block 408. In some embodiments, the processing logic can include controller circuitry to determine to whether the data is written to the first buffer or the second buffer. The controller circuitry can determine whether the second memory buffer is full by comparing a read pointer and a write pointer associated with the second memory buffer, as described above.

At block 406, the processing logic can bypass the first memory buffer and write the data to the second memory buffer according to the first clock domain.

At block 408, the processing logic can write the data to the first buffer according to the first clock domain. In some embodiments, the processing logic can include controller circuitry, such as controller circuitry 220 of FIG. 2, to manage a read pointer and a write pointer associated with the first buffer. The write pointer indicates a first address to write to the first buffer and the read pointer indicates a second address to read from the first buffer.

At block 410, the processing logic can determine that the first buffer is not empty.

At block 412, responsive to the determination that the first buffer is not empty, the processing logic can read the data from the first buffer.

At block 414, the processing logic can write the data to the second buffer.

At block 416, the processing logic can read the data from the second buffer according to the second clock domain. In some embodiments, the second buffer can include a CDC latch array, such as a CDC latch array 212, to synchronize the data when transferring the data from the source clock domain to the destination clock domain. For example, the CDC latch array can include two or more latches/flip-flops to mitigate metastability while transferring the data from the source clock domain to the destination clock domain.

At block 418, the processing logic can provide the first data as output. For example, the processing logic can provide the first data as output to the destination circuitry according to a destination clock domain associated with the destination circuitry.

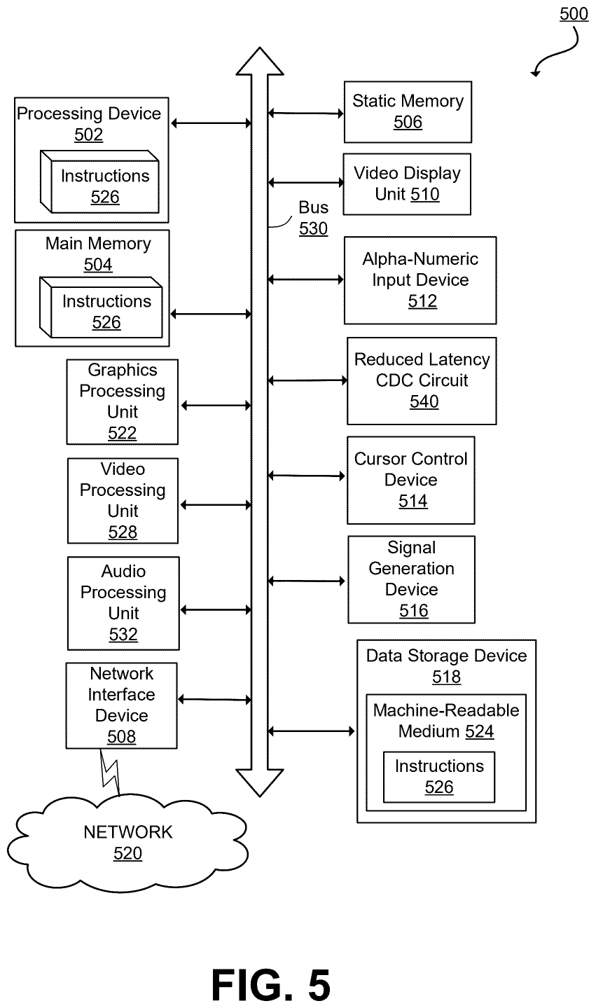

FIG. 5 illustrates an example machine of a computer system 500 within which a set of instructions, for causing the machine to perform any one or more of the methodologies discussed herein, can be executed. In alternative implementations, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device can be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application-specific integrated circuit (ASIC), a field programmable gate array (FPGA), a digital signal processor (DSP), network processor, or the like. The processing device 502 can be configured to execute instructions 526 for performing the operations and steps described herein.

The computer system 500 can further include a network interface device 508 to communicate over the network 520. The computer system 500 also can include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), video processing unit 528, and audio processing unit 532.

The computer system 500 can further include a reduced latency CDC circuit 540 for performing the operations described herein.

The data storage device 518 can include a machine-readable storage medium 524 (also known as a non-transitory computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine, allowing the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm can be a sequence of operations leading to a desired result. The operations are those requiring physical manipulations of physical quantities. Such quantities can take the form of electrical or magnetic signals capable of being stored, combined, compared, and otherwise manipulated. Such signals can be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus can be specially constructed for the intended purposes, or it can include a computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems can be used with programs in accordance with the teachings herein, or it can prove convenient to construct a more specialized apparatus to perform a similar sequence of procedures. In addition, the present disclosure is not described with reference to any particular programming language, and any one in use in such computer systems can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read-only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications can be made thereto without departing from the broader spirit and scope of implementations of the disclosure as set forth in the following claims. Where the disclosure refers to some elements in the singular tense, more than one element can be depicted in the figures, and like elements are labeled with like numerals. The disclosure and drawings are, accordingly, to be regarded in an illustrative sense rather than a restrictive sense.

What is claimed is:

1. A clock domain crossing (CDC) circuit to receive a first data, wherein the CDC circuit comprises:
a first buffer comprising a single-clock static random-access memory (SRAM) operating according to a first clock domain, wherein the first buffer is coupled to an input of the CDC circuit;
a second buffer comprising a plurality of data flip-flops (DFF) coupled to the input of the CDC circuit and to the first buffer; and
logic coupled to the first buffer and the second buffer, wherein the logic is to:
determine that the second buffer is not full at a first time; and
responsive to the determination that the second buffer is not full at the first time, bypass the first buffer to write the first data to the second buffer according to the first clock domain; and
provide the first data as output from the second buffer according to a second clock domain.

2. The CDC circuit of claim 1, wherein the CDC circuit is further to receive a second data at a second time, and wherein the logic is further to:
determine that the second buffer is full or that the first buffer is not empty at the second time; and
responsive to the determination that the second buffer is full or that the first buffer is not empty at the second time, write the second data to the first buffer according to the first clock domain.

3. The CDC circuit of claim 2, wherein the logic is further to:
determine that the first buffer is not empty;
responsive to the determination that the first buffer is not empty, read the second data from the first buffer; and
write the second data to the second buffer.

4. The CDC circuit of claim 1, wherein the logic comprises controller circuitry, wherein the controller circuitry is to:
manage a write pointer, wherein the write pointer indicates a first address to write to the first buffer; and
manage a read pointer, wherein the read pointer indicates a second address to read from the first buffer.

5. The CDC circuit of claim 1, wherein the second buffer further comprises:
a CDC latch array, wherein the CDC latch array is to:
synchronize the first data; and
provide the first data as output according to the second clock domain.

6. The CDC circuit of claim 1, wherein the first clock domain is received over an external link, wherein the first clock domain is a variable clock domain based on a link speed associated with the external link.

7. The CDC circuit of claim 1, wherein the first buffer and the second buffer are first-in, first-out memory buffers.

8. An integrated circuit (IC) comprising:
a first circuit operating according to a first clock domain; and
a second circuit operating according to a second clock domain; and
a clock domain crossing (CDC) circuit coupled to the first circuit and the second circuit, wherein CDC circuit comprises a first buffer and a second buffer, and wherein the CDC circuit is to:
receive a first data from the first circuit according to the first clock domain at a first time;
determine that the second buffer of the CDC circuit is not full at the first time, wherein the second buffer comprises a plurality of data flip-flops (DFF);
responsive to the determination that the second buffer is not full at the first time, bypass the first buffer to write the first data to the second buffer according to the first clock domain, wherein the first buffer comprises a single-clock SRAM; and
provide the first data as output from the second buffer to the second circuit according to the second clock domain.

9. The IC of claim 8, wherein the CDC circuit is further to:
receive a second data at a second time;
determine that the second buffer is full or that the first buffer is not empty at the second time; and
responsive to the determination that the second buffer is full or that the first buffer is not empty at the second time, write the second data to the first buffer according to the first clock domain.

10. The IC of claim 9, wherein the CDC circuit is further to:
determine that the first buffer is not empty;
responsive to the determination that the first buffer is not empty, read the second data from the first buffer; and
write the second data to the second buffer.

11. The IC of claim 8, wherein the CDC circuit further comprises controller circuitry, and wherein the controller circuitry is to:
manage a write pointer, wherein the write pointer indicates a first address to write to the first buffer; and
manage a read pointer, wherein the read pointer indicates a second address to read from the first buffer.

12. The IC of claim 8, wherein the second buffer further comprises:
a CDC latch array, wherein the CDC latch array is to:
synchronize the first data; and
provide the first data as output according to the second clock domain.

13. The IC of claim 8, wherein the first clock domain is received over an external link, and wherein the first clock domain is a variable clock domain based on a link speed associated with the external link.

14. The IC of claim 8, wherein the first buffer and the second buffer are first-in, first-out memory buffers.

15. A method performed by a clock domain crossing (CDC) circuit comprising a first buffer and a second buffer, wherein the first buffer comprises an SRAM operating according to a first clock domain and the second buffer comprises a plurality of data flip-flops (DFF), the method comprising:
receiving a first data at a first time;
determining that the second buffer is not full at the first time;
responsive to determining that the second buffer is not full at the first time, bypassing the first buffer and writing the first data to the second buffer according to the first clock domain;
reading the first data from the second buffer according to a second clock domain; and
providing the data as output.

16. The method of claim 15, further comprising:
receiving a second data at a second time;
determining that the second buffer is full or that the first buffer is not empty at the second time; and
responsive to the determining that the second buffer is full or that the first buffer is not empty at the second time, writing the second data to the first buffer according to the first clock domain.

17. The method of claim 16, further comprising:
determining that the first buffer is not empty;
responsive to the determining that the first buffer is not empty, reading the second data from the first buffer; and
writing the second data to the second buffer.

18. The method of claim 15, further comprising:
managing a write pointer, wherein the write pointer indicates a first address to write to the first buffer; and
managing a read pointer, wherein the read pointer indicates a second address to read from the first buffer.

19. The method of claim 15, wherein the second buffer further comprises a CDC latch array, and wherein the method further comprises:
synchronizing the first data using a CDC latch array.

20. The method of claim 15, further comprising:
receiving the first clock domain over an external link, wherein the first clock domain is a variable clock domain based on a link speed associated with the external link.
